(19) United States
(12) Patent Application Publication
(10) Pub. No.: US 2014/0040072 A1
(43) Pub. Date: Feb. 6, 2014

(54) REAL ESTATE DATA EXCHANGE SYSTEM

(71) Applicants: Michael James Leavy, Santa Cruz, CA (US); Alan Kerry Lewis, Santa Clara, CA (US); Catherine Elizabeth Tiritoglu, Sunnyvale, CA (US); Cameron Thomas Bigger, Los Altos, CA (US); Susan Eliot Briggs, Portola Valley, CA (US); Kurtis Derry, San Jose, CA (US)

(72) Inventors: Michael James Leavy, Santa Cruz, CA (US); Alan Kerry Lewis, Santa Clara, CA (US); Catherine Elizabeth Tiritoglu, Sunnyvale, CA (US); Cameron Thomas Bigger, Los Altos, CA (US); Susan Eliot Briggs, Portola Valley, CA (US); Kurtis Derry, San Jose, CA (US)

(73) Assignee: MOVE, INC., Westlake Village, CA (US)

(21) Appl. No.: 13/564,020

(22) Filed: Aug. 1, 2012

(51) Int. Cl. G06Q 30/00

(52) U.S. Cl. 705/26.61; 705/27.1

(57) ABSTRACT

A method, apparatus and computer program product are provided for allowing multiple users to view and exchange real estate data in real time. In the context of a method, a method is provided that includes causing an invitation to connect with an agent account to be transmitted form an agent device associated with the agent account to a client device associated with a client account. The method further includes receiving an indication of acceptance of the invitation from the client device and, in response, establishing an agent-client connection between the agent account and the client account, the agent-client connection allows information regarding real estate to be shared between an agent and a client via a customized user interface of a respective one of the agent device or the client device.

### FIELD OF APPLICATION

Embodiments of the present invention relate generally to systems, methods, and computer program products for interacting with real estate data, and more particularly to systems, methods, and computer program products which allow multiple users to view and exchange real estate data in real time.

### BACKGROUND

The process of purchasing a new home through a real estate agent can often lead to redundancies and information bottlenecks. Due to the amount of information available on the internet, both the agent and client may be actively involved in the search process, but neither may have knowledge of what the other has found or is interested in without scheduling face to face meetings or phone calls, or exchanging emails. Properties of interest might be shared between agent and client through disparate mediums, such as being described over the phone or in an email, by sending links to web pages, or through physical pamphlets, which may be inefficient and disjointed. These issues can be compounded by the mobility of modern real estate agents, over 75% of which work outside a traditional office. Both agents and clients may be difficult to reach at times, and often times one of the two will not have access to the medium through which the other wishes to share their latest property discovery.

### SUMMARY

A method, apparatus and computer program product are therefore provided according to an example embodiment of the present invention for allowing multiple users to view and exchange real estate data in real time. In this regard, the method, apparatus, and computer program product of one embodiment may allow an agent to invite a client to connect with them, thereby establishing an agent-client connection which allows both users to share and view real estate data via customized user interfaces of their respective devices.

In one embodiment, a method is provided that includes causing an invitation to connect with an agent account to be transmitted from an agent device associated with the agent account to a client device associated with a client account. The method further includes receiving an indication of acceptance of the invitation from the client device and, in response, establishing an agent-client connection between the agent account and the client account. The agent-client connection allows information regarding real estate to be shared between an agent and a client via a customized user interface of a respective one of the agent device or the client device.

In another embodiment, a method is provided that further includes receiving a search query from the agent device or the client device and, in response, causing one or more property listings to be provided to the agent device or client device. The method further includes receiving selection of one or more of the property listings via the customized user interface of the agent device or the customized user interface of the client device and causing the selected one or more property listings to be provided to the other of the agent device or the client device.

In a further embodiment, an apparatus is provided that includes at least one processor and at least one memory including program code instructions, the at least one memory and the program code instructions being configured to, with the processor, direct the apparatus to at least cause an invitation to connect with an agent account to be transmitted from an agent device associated with the agent account to a client device associated with a client account. The apparatus is further directed to receive an indication of acceptance of the invitation from the client device and, in response, establish an agent-client connection between the agent account and the client account. The agent-client connection allows information regarding real estate to be shared between an agent and a client via a customized user interface of a respective one of the agent device or the client device.

In another embodiment, an apparatus is provided that includes at least one processor and at least one memory including program code instructions, the at least one memory and the program code instructions being configured to, with the processor, direct the apparatus to at least receive a search query from the agent device or the client device and, in response, cause one or more property listings to be provided to the agent device or client device. The apparatus is further directed to receive selection of one or more of the property listings via the customized user interface of the agent device or the customized user interface of the client device and cause the selected one or more property listings to be provided to the other of the agent device or the client device.

In an even further embodiment, a computer program product is provided that includes a non-transitory computer readable medium storing program code portions therein. The computer program code instructions are configured to, upon execution, direct an apparatus to at least cause an invitation to connect with an agent account to be transmitted from an agent device associated with the agent account to a client device associated with a client account. The apparatus is further directed to receive an indication of acceptance of the invitation from the client device and, in response, establish an agent-client connection between the agent account and the client account. The agent-client connection allows information regarding real estate to be shared between an agent and a client via a customized user interface of a respective one of the agent device or the client device.

In another embodiment, a computer program product is provided that includes a non-transitory computer readable medium storing program code portions therein. The computer program code instructions are configured to, upon execution, direct an apparatus to at least receive a search query from the agent device or the client device and, in response, cause one or more property listings to be provided to the agent device or client device. The apparatus is further directed to receive selection of one or more of the property listings via the customized user interface of the agent device or the customized user interface of the client device and cause the selected one or more property listings to be provided to the other of the agent device or the client device.

In a still further embodiment, an apparatus is provided that includes means for causing an invitation to connect with an agent account to be transmitted from an agent device associated with the agent account to a client device associated with a client account. The apparatus further includes means for receiving an indication of acceptance of the invitation from the client device and means for establishing an agent-client connection between the agent account and the client account in response to receiving the indication of acceptance. The agent-client connection allows information regarding real estate to be shared between an agent and a client via a customized user interface of a respective one of the agent device or the client device.

In another embodiment, an apparatus is provided that includes means for receiving a search query from the agent device or the client device and means for causing one or more property listings to be provided to the agent device or client device. The apparatus further includes means for receiving selection of one or more of the property listings via the customized user interface of the agent device or the customized user interface of the client device and means for causing the selected one or more property listings to be provided to the other of the agent device or the client device.

### BRIEF DESCRIPTION OF THE SEVERAL VIEWS OF THE DRAWING(S)

Reference will now be made to the accompanying drawings, which are not necessarily drawn to scale.

FIG. 1 is a schematic representation of a real estate data exchange (REDE) system configured in accordance with an example embodiment;

FIG. 2 is a block diagram of an apparatus that may be embodied by or associated with an electronic device, and may be configured to implement example embodiments of the present invention;

FIG. 3 is a flowchart illustrating operations performed and signals transmitted in accordance with an embodiment of the present invention;

FIGS. 4 through 19 are schematic representations of customized user interfaces configured in accordance with embodiments of the present invention.

### DETAILED DESCRIPTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

The present application is generally directed to systems, methods, and computer program products for viewing and interacting with real estate data, and more particularly to systems, methods, and computer program products for allowing multiple users to view and exchange real estate data in real time. Embodiments of such real estate data exchange (REDE) systems, methods, and computer program products can be configured to allow an agent-client connection to be established between an agent and client account, allowing information regarding real estate to be shared between an agent and a client via a customized user interface of a respective one of the agent device or the client device. For example, clients may search for real estate property and share property listings which they are interested in with their agent, such as by requesting a showing. Similarly, agents may search for real estate property and share property listings which they think one or more clients may be interested in, such as by suggesting the property to one or more of their clients. Whether the agent has shared a property listing with a client, or a client with their agent, the user with whom the property is shared may receive a notification that a property was shared with them and may be permitted to view the listing on their device. The agent-client connection may also allow a connected agent and client to discuss properties, such as through a messaging system that may be presented alongside the property listing being discussed. By facilitating real time communication and collaboration, the REDE systems, methods, and computer program products may enhance and strengthen the agent-client relationship, allowing both parties to more effectively work towards the common goal of purchasing a piece of property. In hot real estate markets, where hours and even minutes can make or break a deal, real estate agents with tools that ensure an efficient bi-directional flow of information between themselves and their clients may have an enormous advantage over their competition. Moreover, clients with access to such tools may be provided with a more seamless and less stressful property-buying experience. Many other features and benefits may be provided by the REDE systems, methods, and computer program products, as will be discussed in greater detail below.

In this regard, embodiments of the present invention will be described more fully hereinafter with reference to the accompanying drawings. It should be understood that these drawings show some, but not all, embodiments of the invention. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received, processed and/or stored in accordance with embodiments of the present invention. Thus, use of any such terms should not be taken to limit the spirit and scope of embodiments of the present invention.

Additionally, as the term will be used herein, “circuitry” may refer to hardware-only circuit implementations (e.g., implementations in analog circuitry and/or digital circuitry); combinations of circuits and computer program product(s) including software and/or firmware instructions stored on one or more computer readable memories that work together to cause an apparatus to perform one or more functions described herein; and circuits, such as, for example, one or more microprocessors or portions of a microprocessors, that require software or firmware for operation even if the software or firmware is not physically present. This definition of “circuitry” is applicable to all uses of this term, including in any claims. As another example, the term “circuitry” also includes implementations comprising one or more processors and/or portion(s) thereof and accompanying software and/or firmware. As another example, the term “circuitry” also includes, for example, an integrated circuit or applications processor integrated circuit for a portable communication device or a similar integrated circuit in a server, a network device, and/or other computing device.

As defined herein, a “computer-readable storage medium” refers to a non-transitory physical storage medium (e.g., volatile or non-volatile memory device), and can be differentiated from a “computer-readable transmission medium,” which refers to an electromagnetic signal.

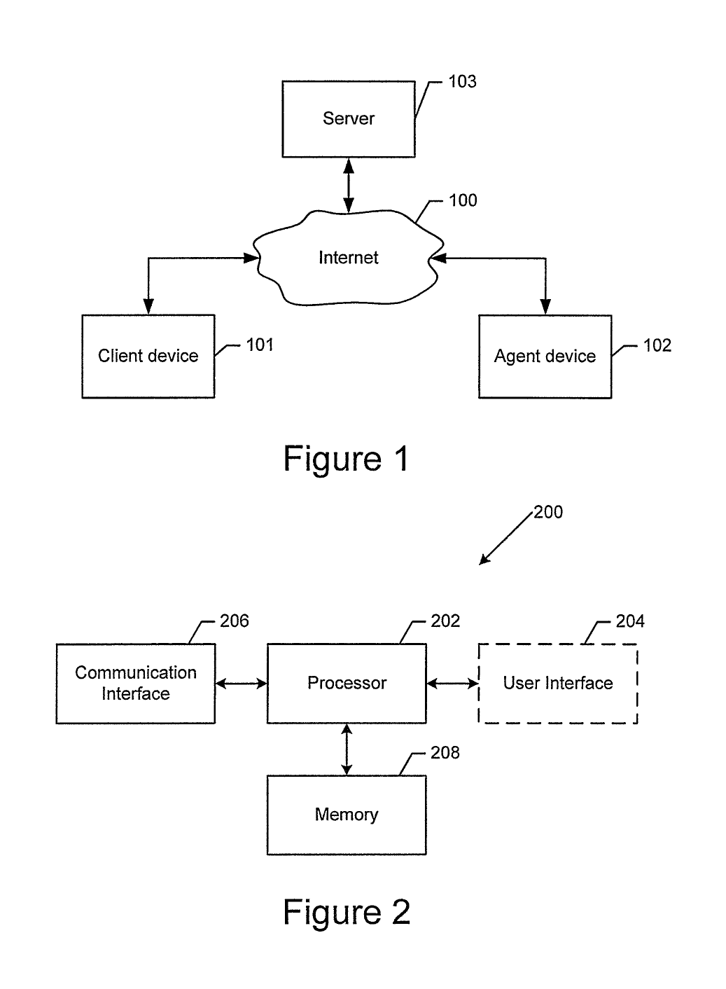

FIG. 1 illustrates a block diagram of an REDE system. While FIG. 1 illustrates one example of a configuration of an REDE system, numerous other configurations may be used to implement embodiments of the present invention. With reference to FIG. 1, however, the REDE system may include a client device 101, an agent device 102, and a network entity, such as a server 103. The client device 101 and agent device 102 may be any device that is configured to communicate over one or more common networks, e.g., a network which both devices are connected to, such as the internet 100. For example, the client and agent devices 101 and 102 may be mobile terminals, such as mobile telephones, PDAs, pagers, laptop computers, tablet computers, or any of numerous other hand held or portable communication devices, computation devices, content generation devices, content consumption devices, or combinations thereof. The server 103 may be any type of network-accessible device that includes storage and may be configured to communicate with the client device 101 and the agent device 102 over one or more common networks, such as the internet 100. The server 103 may store account information, real estate information, such as property listings, and information describing or otherwise relating to agent-client connections, along with any other conceivable types of content, data or the like which may, for example, be provided to the client device 101 or the agent device 102 during use of the REDE system. The server 103 may also communicate with other servers or devices, such as other client and agent devices, as well as other servers or data terminals including servers and systmes providing real estate data, such as Multiple Listing Services (MLS) data, over one or more networks, such as the internet 100. The client device 101, agent device 102, and/or server 103 may include or be associated with an apparatus 200, such as shown in FIG. 2, configured in accordance with embodiments of the present invention, as described below.

As shown in FIG. 1 and mentioned above, the client device 101, agent device 102, and server 103 may communicate with one another via a common network, such as the internet 100. Client device 101, agent device 102, and server 103 may connect to the common network, e.g., the internet 100, via wired or wireless means, such as via one or more intermediate networks. For example, devices 101 and 102 or server 103 may connect with the common network, e.g., the internet 100, via wired means such as Ethernet, USB (Universal Serial Bus), or the like, or via wireless means such as, for example, WI-FI, BLUETOOTH, or the like, or by connecting with a wireless cellular network, such as a Long Term Evolution (LTE) network, an LTE-Advanced (LTE-A) network, a Global Systems for Mobile communications (GSM) network, a Code Division Multiple Access (CDMA) network, e.g., a Wideband CDMA (WCDMA) network, a CDMA2000 network or the like, a General Packet Radio Service (GPRS) network or other type of network.

Example embodiments of the invention will now be described with reference to FIG. 2, in which certain elements of an apparatus 200 for carrying out various functions of the REDE system are depicted. As noted above, in order to implement the various functions of the REDE system, the apparatus 200 of FIG. 2 may be employed, for example, in conjunction with any or all of user and agent devices 101 and 102 and server 103 of FIG. 1. However, it should be noted that the apparatus 200 of FIG. 2 may also be employed in connection with a variety of other devices, both mobile and fixed, in order to implement the various functions of the REDE system and therefore, embodiments of the present invention should not be limited to those depicted. It should also be noted that while FIG. 2 illustrates one example of a configuration of an apparatus 200 for implementing the functions of the REDE system, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 200 for implementing the various functions of the REDE system may include or otherwise be in communication with a processor 202, a communication interface 206, and a memory device 208. As described below and as indicated by the dashed lines in FIG. 2, the apparatus 200 may also include a user interface 204, such as when the apparatus 200 is embodied by or otherwise associated with a client device 101 or an agent device 102. In some embodiments, the processor 202 (and/or co-processors or other processing circuitry assisting or otherwise associated with the processor 202) may be in communication with the memory device 208 via a bus configured to pass information among components of the apparatus 200. The memory device 208 may, for example, include one or more volatile and/or non-volatile memories. The memory device 208 may be configured to store information, data, content, applications, instructions, or the like, for enabling the apparatus 200 to carry out various functions in accordance with an example embodiment of the present invention. For example, the memory device 208 may be configured to store instructions, such as program code instructions, that, when execution by the processor 202, cause the apparatus 200 to carry out various operations.

The processor 202 may be embodied in a number of different ways. For example, the processor 202 may be embodied as one or more of a variety of hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 202 may include one or more processing cores configured to perform independently. A multi-core processor may enable multiprocessing within a single physical package. Additionally or alternatively, the processor 202 may include one or more processors configured in tandem via the bus to enable independent execution of instructions, pipelining and/or multithreading.

In an example embodiment, the processor 202 may be configured to execute instructions stored in the memory device 208 or otherwise accessible to the processor 202. Alternatively or additionally, the processor 202 may be configured to execute hard coded functionality. As such, whether configured by hardware or software methods, or by a combination thereof, the processor 202 may represent an entity (e.g., physically embodied in circuitry) capable of performing operations according to an embodiment of the present invention while configured accordingly. Thus, for example, when the processor 202 is embodied as an ASIC, FPGA or the like, the processor 202 may be specifically configured hardware for conducting the operations described herein. Alternatively, as another example, when the processor 202 is embodied as an executor of software instructions, the instructions may specifically configure the processor 202 to perform the algorithms and/or operations described herein when the instructions are executed. However, in some cases, the processor 202 may be a processor of a specific device (e.g., the client device 101, agent device 102, or server 103) configured to employ an embodiment of the present invention by further configuration of the processor 202 by instructions for performing the algorithms and/or operations described herein. The processor 202 may include, among other things, a clock, an arithmetic logic unit (ALU) and logic gates configured to support operation of the processor 202.

Meanwhile, the communication interface 206 may be any means such as a device or circuitry embodied in either hardware or a combination of hardware and software that is configured to receive and/or transmit data from/to a network, such as the internet 100, and/or any other device or module in communication with the apparatus 200. In this regard, the communication interface 206 may include, for example, an antenna (or multiple antennas) and supporting hardware and/or software for enabling communications with a wireless communication network. Additionally or alternatively, the communication interface 206 may include the circuitry for interacting with the antenna(s) to cause transmission of signals via the antenna(s) or to handle receipt of signals received via the antenna(s). In some environments, the communication interface 206 may alternatively or also support wired communication. As such, for example, the communication interface 206 may include a communication modem and/or other hardware/software for supporting communication via cable, digital subscriber line (DSL), universal serial bus (USB) or other mechanisms.

In some embodiments, such as instances in which the apparatus 200 is embodied by the client device 101 or agent device 102, the apparatus 200 may include a user interface 204 in communication with the processor 202 to receive indications of user input and to cause audible, visual, mechanical or other output to be provided to the user. As such, the user interface 204 may, for example, include a keyboard, a mouse, a joystick, a display, a touch screen(s), touch areas, soft keys, a microphone, a speaker, or other input/output mechanisms. The processor 202 may be configured to control one or more functions of one or more user interface elements through computer program instructions (e.g., software and/or firmware) stored on a memory accessible to the processor 202 (e.g., memory device 208). In other embodiments, however, such as in instances in which the apparatus 200 is embodied by server 103, the apparatus 200 may not include a user interface 204.

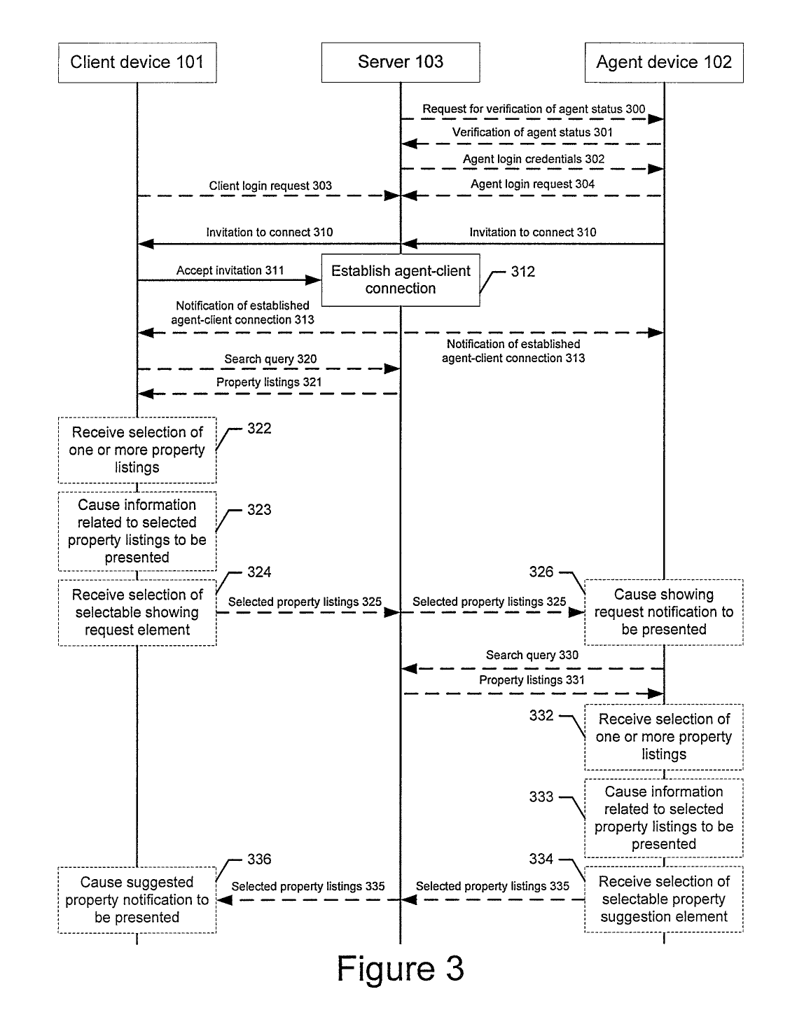

Referring now to FIG. 3, various operations of the REDE system are depicted. As described below, the operations of FIG. 3 may be performed by one or more of apparatus 200, such as shown in FIG. 2, embodied by or otherwise associated with client device 101, agent device 102, and/or server 103. In this regard, apparatus 200 embodied by or otherwise associated with agent device 102 may include means, such as the processor 202, the memory 208, the user interface 204, the communication interface 206 and/or the like, for causing an invitation to connect with an agent account to be transmitted from the agent device 102 to the client device 101. See operation 310 of FIG. 3. According to an example embodiment, the invitation may be sent directly from an agent device 102 to a client device 101 or, according to another embodiment, and as depicted in FIG. 3, the invitation may be transmitted via server 103, such as via an apparatus 200 associated with server 103.

The apparatus 200 embodied by or otherwise associated with server 103 may include means, such as those mentioned above, for receiving an indication of acceptance of the invitation from the client device 101. See operation 311. According to another embodiment, the indication of acceptance may be additionally or alternatively received by apparatus 200 associated with agent device 102, such as via the means discussed above. Thus, the indication of acceptance may, for example, be received by the server 103, by the agent device 102, or by both, e.g., by the agent device 102 via the server 103. The apparatus 200 embodied by or otherwise associated with the server 103 may also include means, such as those mentioned above, for establishing an agent-client connection between the agent account associated with the agent device 102 and the client account associated with the client device 101. See operation 312. The agent-client connection allows information regarding real estate to be shared between an agent and client via respective customized user interfaces of the agent 102 and client 101 devices. Following the establishment of the agent-client connection, notifications of the established agent-client connection may be transmitted, such as by apparatus 200 embodied by or otherwise associated with the server 103, to the client 101 and agent 102 devices. See operation 313.

Before discussing the real estate information sharing functions of the REDE system, the account management functions should be understood. In this regard, as shown in FIG. 3, the apparatus 200 embodied by or otherwise associated with a client device 101 and the apparatus 200 embodied by or otherwise associated with an agent device 102 may, according to an example embodiment, both include means, such as a processor 202, a memory 208, a user interface 204, a communication interface 206 or the like, for causing respective client and agent login requests to be transmitted, the requests respectively including client and agent login credentials. See operations 303 and 304. The client and agent login credentials may include, for example, a login ID and/or password. The client and agent login requests may, for example, be transmitted to an apparatus 200 embodied by or otherwise associated with a server 103 and including means, such as those discussed above, for receiving the requests. The apparatus 200 embodied by or otherwise associated with server 103 may further include means for verifying the client and agent login credentials and, if they can be verified, causing the client 101 and agent 102 devices to be respectively associated with the client and agent accounts.

In some circumstances, it may be beneficial to ensure that a person who wishes to obtain agent login credentials, e.g., a person who wishes to set up an agent account so that they may login as an agent, is actually a real estate agent. Thus, according to an example embodiment, apparatus 200 embodied by or otherwise associated with server 103 may include means, such as those mentioned previously, for requesting verification of an agent status, such as by causing a request for verification to be transmitted to a device, such as agent device 102, being used by a person who is attempting to set up an agent account. See operation 300. In response, the prospective agent user may provide the requested verification, such as via a user interface 204 of apparatus 200 embodied by or otherwise associated with a device, such as agent device 102. See operation 301. Only upon receiving the requested verification of the prospective agent user's agent status will apparatus 200 embodied by or otherwise associated with server 103 provide the prospective agent user with agent login credentials, such as a user name or password, that the prospective agent may use during a subsequent agent login request. See operation 302. Thus, in this way, it may be ensured that any agent user, e.g., any users who login with agent login credentials so as to associate a device with an agent account, is a verified real estate agent.

Turning now to the operations of the REDE system following the establishment of an agent-client connection, the various real estate information sharing features will be discussed. Before proceeding, however, it should be understood that the operations depicted in FIG. 3 do not need to occur in any strict chronological order, such as the order depicted therein. That is, although FIG. 3 depicts a client user searching for and then sharing real estate information, followed by an agent user doing the same, these processes may, according to example embodiments, take place in real time. In other words, the operations may take place in any order and real estate information may be shared simultaneously or even while the receiving user is in the middle of another operation, such as reviewing property listings, or even selecting their own property listings to be shared. As such, FIG. 3 should be interpreted as merely illustrative of just one possible sequence of events and/or operations.

Thus, continuing to refer to FIG. 3, an apparatus 200 embodied by or otherwise associated with a client device 101 or agent device 102 may include means, such as a processor 202, memory 208, user interface 204, communication interface 206 or the like, for causing a search query to be transmitted, such as to an apparatus 200 embodied by or otherwise associated with a server 103 and including means, such as those just mentioned, for receiving the search query. See operations 320 and 330. The apparatus 200 embodied by or otherwise associated with server 103 may further include means, such as those mentioned above, for causing one or more property listings to be provided to the client device 101 or agent device 102 in response to the search query. See operations 321 and 331. Apparatus 200 embodied by or otherwise associated with the client device 101 and the apparatus 200 embodied by or otherwise associated with the agent device 102 may also include means, such as those mentioned above, for receiving the property listings provided by server 103 and for causing them to be displayed, such as via respective customized user interfaces 104.

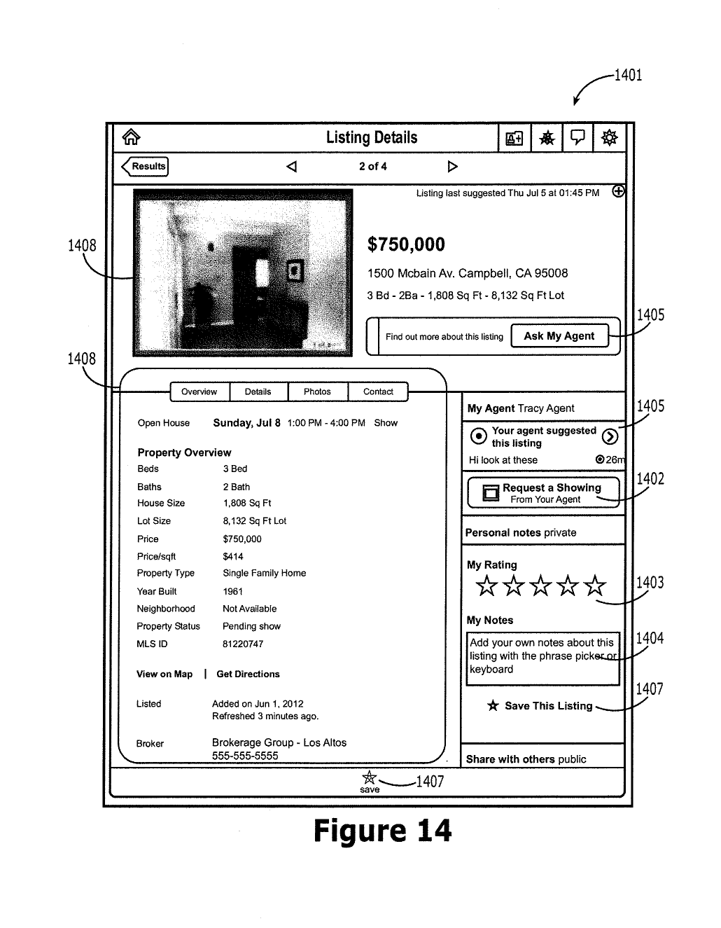

The apparatus 200 embodied by or otherwise associated with the client device 101 and the apparatus 200 embodied by or otherwise associated with the agent device 102 may further include means, such as those discussed above, for receiving selection of one or more of the received property listings and for, in response to receiving the selection, causing information related to the selected property listings to be presented, such as via respective customized user interfaces 204. See operations 322, 323, 332, and 333. The information related to the selected property listings may include any details about the property that may be useful for making a purchasing decision, examples of which are provided, e.g., in FIG. 14, which will be discussed below. The information related to the selected one or more property listings may also include one or more selectable elements. Thus, for example, the apparatus 200 embodied by or otherwise associated with the client device 101 may include means, such as those discussed above, for causing a selectable “showing request” element to be presented, such as via the customized user interface 204. The apparatus 200 embodied by or otherwise associated with agent device 102 may similarly include means, such as those discussed above, for causing a selectable “property suggestion” element to be presented, such as via the customized user interface 204. In this way, according to an example embodiment, an agent using an agent device 102 to view property listings may be provided with the ability to suggest one or more properties that a particular client may be interested in learning more about, directly from the associated property listings. Similarly, and according to another example embodiment, a client using client device 101 to view property listings may be provided with the ability to request that their agent arrange a showing of any properties they are interested in, directly from the associated property listings.

Thus, the apparatus 200 embodied by or otherwise associated with the client device 101 and the apparatus 200 embodied by or otherwise associated with the agent device 102 may further include means, such as those discussed above, for receiving selection of the selectable “showing request” element or selectable “property suggestion” element and for, in response to the selection, causing the selected one or more property listings to be provided to the other device. See operations 324, 325, 334, and 335. Finally, the apparatus 200 embodied by or otherwise associated with the client device 101 and the apparatus 200 embodied by or otherwise associated with the agent device 102 may further include means, such as those discussed above, for, in response to receiving the selected one or more property listings from the other device, causing a notification to be presented, such as via their respective customized user interfaces 204. See operations 326 and 336. For example, a “showing request” notification may be caused to be presented by the apparatus 200 embodied by or otherwise associated with the agent device 102, while a suggested property notification may be caused to be presented by the apparatus 200 embodied by or otherwise associated with the client device 101. The apparatuses 200 respectively associated with the client 101 and agent 102 devices may further include means for receiving selection of the respective “showing request” or “property suggestion” notifications and, in response, causing information related to the property listings to be displayed. It should be understood that the sharing functions discussed above are not limited to scenarios in which property listings are being presented in response to a search query. For example, a client may receive a suggested property from their agent, view the associated property listing, and then select the selectable “showing request” element to request a showing of the suggested property. It will be appreciated by those skilled in the art that many other types of exchanges may be enabled via the means discussed above, and, thus, the possible real estate information exchange scenarios should not be limited to those explicitly described.

Having discussed examples of the types of real estate information sharing functions enabled by the REDE system, examples of some additional features will now be described. In this regard, example embodiments of the REDE system may allow historical information to be retained and viewed. For example, according to one embodiment, the apparatus 200 associated with any of the client device 101, the agent device 102, or the server 103, may include means, such as the processor 202, the memory 208, the communication interface 206 or the like may allow property listings to be stored in one or more lists. For example, property listings which are suggested by an agent user may be stored in a first list, while properties for which a client has requested a showing may be stored in a second list.

Example embodiments of the REDE system may also allow historical information related to actions performed via the client device 101 to be provided to the agent device 102. Thus, the apparatus 200 embodied by or otherwise associated with the client device 101 may include means, such as the processor 202, the memory 208, the user interface 204, the communication interface 206 or the like, for causing historical information regarding actions performed via the client device, such as, for example, viewing property listings, logging in, sending messages, etc., to be stored. The apparatus 200 embodied by or otherwise associated with client device 101 may also include means, such as those just mentioned, for causing this historical information to be provided to the agent device 102, e.g., directly or via the server 103. Accordingly, the apparatus 200 embodied by or otherwise associated with the agent device 102 may include means, such as those mentioned above, for receiving this information and presenting it, such as via the customized user interface 204. In this way, the REDE system may allow an agent to remain informed about how a client is using the REDE system. This may be beneficial, for example, in cases where the client is viewing properties they are interested in, but have not shared these properties, such as via the information sharing mechanisms discussed above.

A further feature of the REDE system may include receiving indications of check-in events. For example, the apparatus 200 respectively associated with either or both of the client device 101 or the agent device 102 may include means, such as those discussed above, to allow a client or agent user to “check in,” e.g., indicate the client or agent's presence, at various locations, such as properties, e.g., when they visit them for a showing. Indications of these check-in events may be stored locally, or on server 103, and may be provided to the non-checking-in device. For example, a client may visit an open house for a property and check-in using the client device 101 and their agent may receive an indication of the check in via the agent device 102. These “check-in” events may, for example, allow agents and clients to be informed about where the other is located during the day, and allow agents and clients to be informed about which properties the other has seen in person.

The REDE system may not only facilitate the sharing of property listings between agents and clients, but may also facilitate discussions about those property listings. In this regard, apparatus 200 embodied by or otherwise associated with user device 101 and apparatus 200 embodied by or otherwise associated with agent device 102 may include means, such as the processor 202, memory 208, user interface 204, the communication interface 206 or the like, for receiving text input related to one or more property listings. The text input, for example, may be personal notes on a property listing, e.g., notes that may be intended only for the reference of the person entering the notes. That is, the text comprising the personal notes may be stored locally, such as in the memory 208 embodied by or otherwise associated with the client 101 or agent 102 device, or remotely, such as in the memory 208 embodied by or otherwise associated with the server 103, such that the personal notes are not shared, or not immediately shared, with another user.

The text input may also be a message, such as a comment or question regarding the property listing, which would be shared with the other user. In this regard, the respective apparatus 200 embodied by or otherwise associated with the client 101 or agent 102 devices may further include means, such as those discussed above, for causing the message to be provided to the other of the agent 102 or client 101 device. Thus, the respective apparatuses 200 embodied by or otherwise associated with the client 101 or agent 102 devices may include corresponding means, such as those discussed above, for receiving the message. The apparatus 200 embodied by or otherwise associated with server 103 may also include means for receiving and storing the message. Thus, the messages exchanged regarding a given property listing may be stored and associated with the property listing, such as by apparatus 200 associated with server 103, such that when the client or agent views the property listing, the associated messages may be presented, or presented in response to receiving an indication from a user to show the messages, along with, e.g., in conjunction with, information regarding the property listing. Attachments may also be included in the messages, such as photos, documents, or any other type of file, data, or content. Thus, the respective apparatuses 200 embodied by or otherwise associated with the client 101 or agent 102 devices may include corresponding means, such as those discussed above, for receiving input indicating a file to be attached to the message, and for providing the file to the other of the agent or client device along with the message.

It should be understood that the REDE system is not limited to one-to-one agent-client connections, nor is it limited to only agent-client connections. In this regard, all of the means discussed above may also enable an invitation to connect with an agent account to be transmitted to a second client device, and for a second agent-client to be established. Thus, the REDE system may allow a single agent to establish agent-client connections with a plurality of clients. In such a scenario, apparatus 200 embodied by or otherwise associated with agent device 102 may further include means, such as processor 202, memory 208, user interface 204, the communication interface 206 or the like, for permitting an agent to select one or more intended clients that will be the target of any given message, property suggestion, or the like, and for permitting an agent to select one or more intended clients for which the agent desires to view information, such as showing requests, messages, usage history, saved properties, or the like. Additionally, the REDE system may also provide the ability to establish agent-agent connections using the means discussed above. This may allow, for example, real estate agents in the same office or organization to share and discuss property listings in a manner similar to the agent-client connection. Finally, the REDE system may also provide the ability to establish client-client connections using the means discussed above. This may allow, for example, friends or family members to share and discuss property listings in a manner similar to the agent-client connection. Connections may be independent of one another, such that information shared between two clients via a client-client connection (e.g., a husband and wife) may not be provided to an agent connect to one or both clients via an agent-client connection. Alternatively, connections may be linked such that information sent by an agent to one client (e.g., the wife) is also provided, e.g., automatically without requiring further actions on the part of the agent or receiving client, to the other client (e.g., the husband) with whom the wife has a client-client connection.

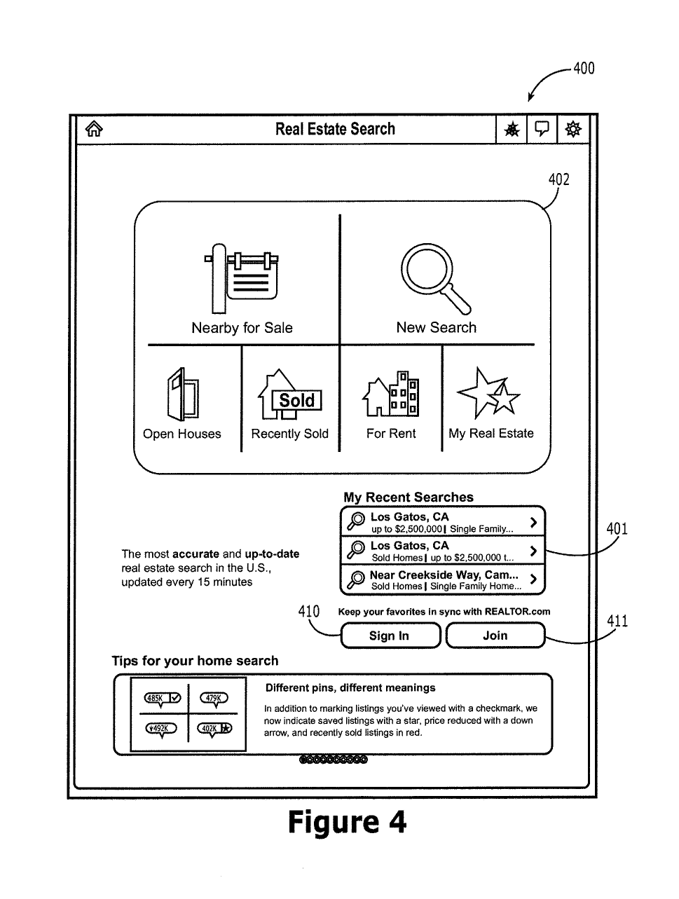

As mentioned above, the operations of the REDE system may involve presenting information and receiving user input via respective customized user interfaces of the client 101 and agent 102 devices, such as via the user interface 204 of the respective apparatus 200 associated therewith. Thus, having discussed examples of operations and features of the REDE system generally, reference will now be made to FIGS. 4-20 in order to discuss specific examples of customized user interfaces which allow client and agent users to interact with the REDE system and enjoy the benefits of its various functions. Before proceeding, it should be understood that, for the sake of simplicity, the Figures will be described as being either from the client's or the agent's perspective. If a view, e.g., a viewable area, is described as being from the client's perspective, this means that the view represents a view presented via the customized user interface 204 of the apparatus 200 embodied by or otherwise associated with a client device 101, e.g., with a device that has been associated with a client account, such as via the login process discussed previously. Similarly, if a view is described as being from the agent's perspective, this means that the view represents a view presented via the customized user interface 204 of the apparatus 200 embodied by or otherwise associated with an agent device 102, e.g., with a device that has been associated with an agent account, such as via the login process discussed previously.

FIG. 4 represents an example of a non-customized home screen viewable area 400, e.g., a view that a user would see before the user logs in. Many of the elements shown in this view may remain after the user has logged in and elements of the agent or client customized user interface have been added. For example, selectable home screen elements 402 and/or recent searches 401 may continue to be displayed after a client or agent logs in. The non-customized home screen view 400 may also include options for signing in 410 and for creating an account 411.

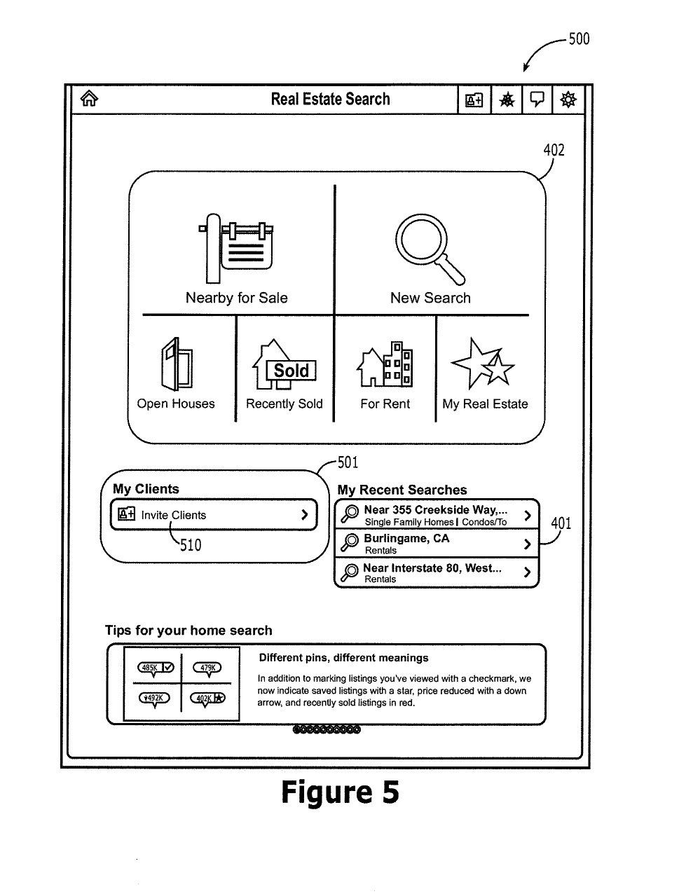

FIG. 5 depicts a customized home screen viewable area 500 from the agent's perspective. In this view, a “my clients” element 501 may be provided to show the user (in this case, an agent) the clients with whom an agent-client connection has been established. In the depicted example, the agent is not yet connected to any clients. That is, no agent-client connections involving the logged-in agent account have been established. Selecting the “invite clients” selectable element 510 may permit the agent to send an invitation to connect with their associated agent account, as discussed above.

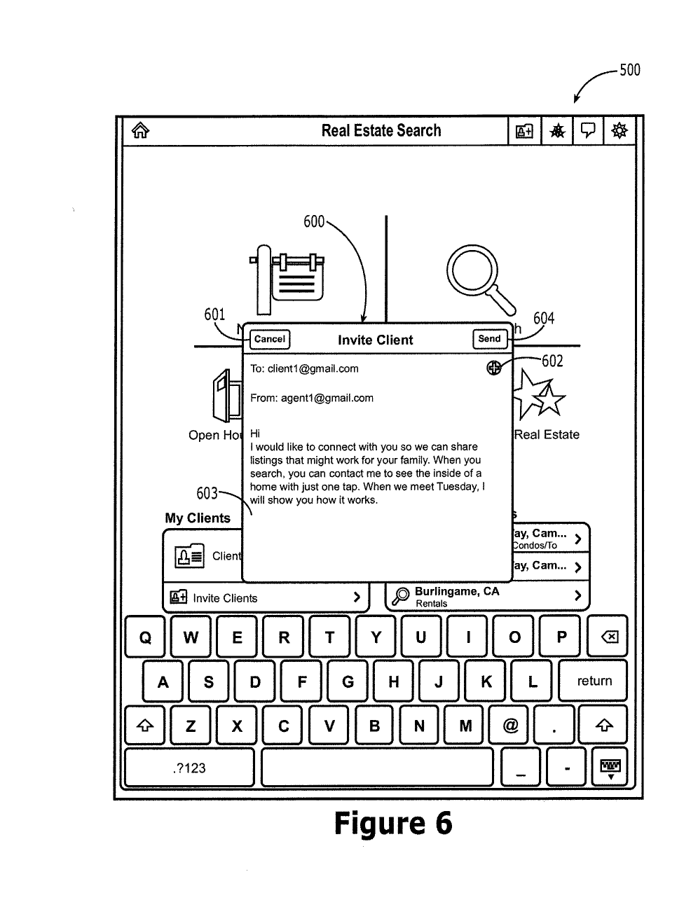

FIG. 6 depicts a “client invite” viewable area 600 from the agent's perspective which may, for example, be presented in response to selecting the “invite clients” selectable element 510 depicted in FIG. 5. As can be seen in FIG. 6, the “client invite” viewable area 600 may include one or more text input area for composing invitations to one or more clients. In this regard, the agent may enter one or more clients to which the agent wishes to send invitations, such as by manually entering them (e.g., entering an email address or other client identifier) in the “To” text input area 601, or by selecting the “add multiple clients” selectable element 602. The agent may enter a customized message to accompany the invitation via the “custom message” text input area 603. The invitation may be sent to the one or more clients, for example, in response to selecting the “send” selectable element 604. It should be understood that the REDE system may allow invitations and, indeed, all messages from an agent to be sent “blind.”That is, the agent may send a single message to a plurality of clients, but have the message appear to each client to have been only sent to him or her.

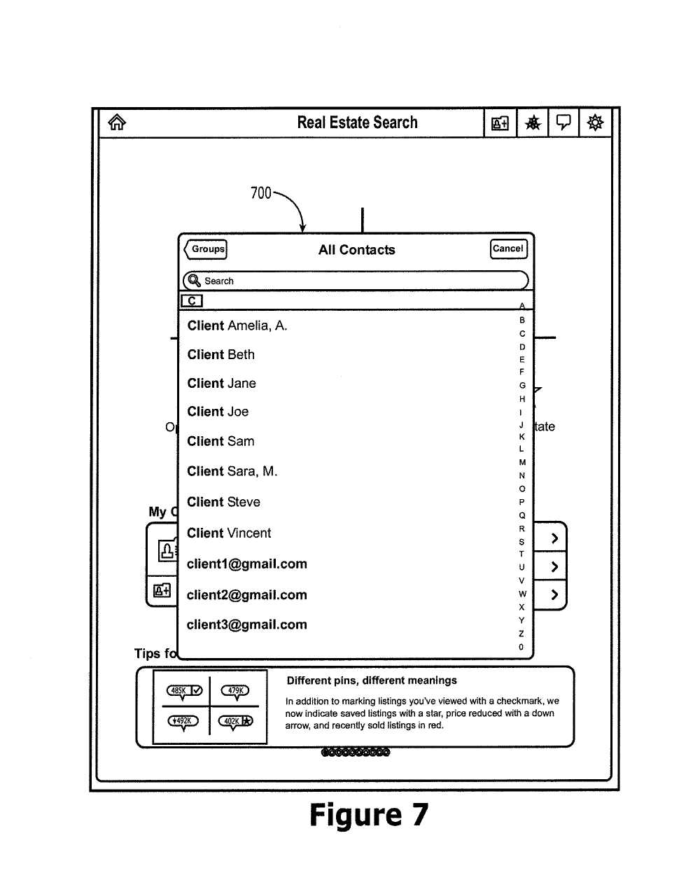

FIG. 7 depicts a “multiple client invite” viewable area 700 from the agent's perspective. The “multiple client invite” viewable area 700 may, for example, be presented in response to selecting the “add multiple clients” selectable element 602 depicted in FIG. 6. As shown, the “multiple client invite” viewable area 700 may comprise a contact list which may present an address book associated with the agent or the agent's account. Thus, the address book may, for example, be an address book stored on, or otherwise associated, with the agent device 102. For example, if agent device 102 is a cell phone, the address book may simply be the address book stored in or otherwise accessible to the cell phone. The address book may also, for example, be an address book associated with the agent account which may be stored, for example, on server 103. The agent may select one or more clients from this view so as to add them to the list of people an invitation will be sent to.

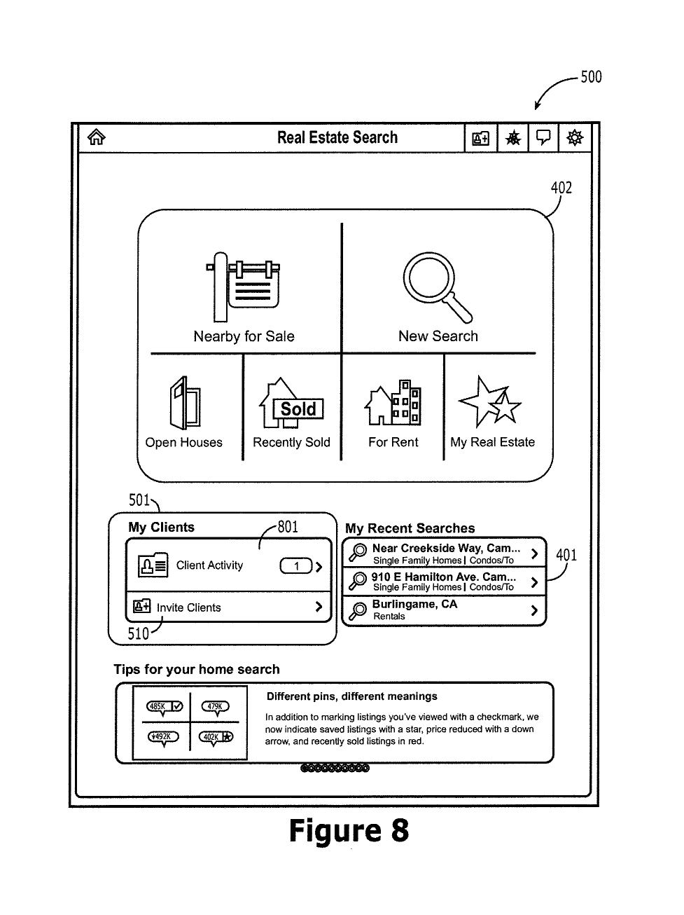

FIG. 8 depicts the customized home screen viewable area 500 from the agent's perspective depicted in FIG. 5; however, in this view a client has accepted an invitation to connect with the agent. Thus, the “my clients” element 501 is now populated with a client and a new “client activity” selectable element 801 is presented.

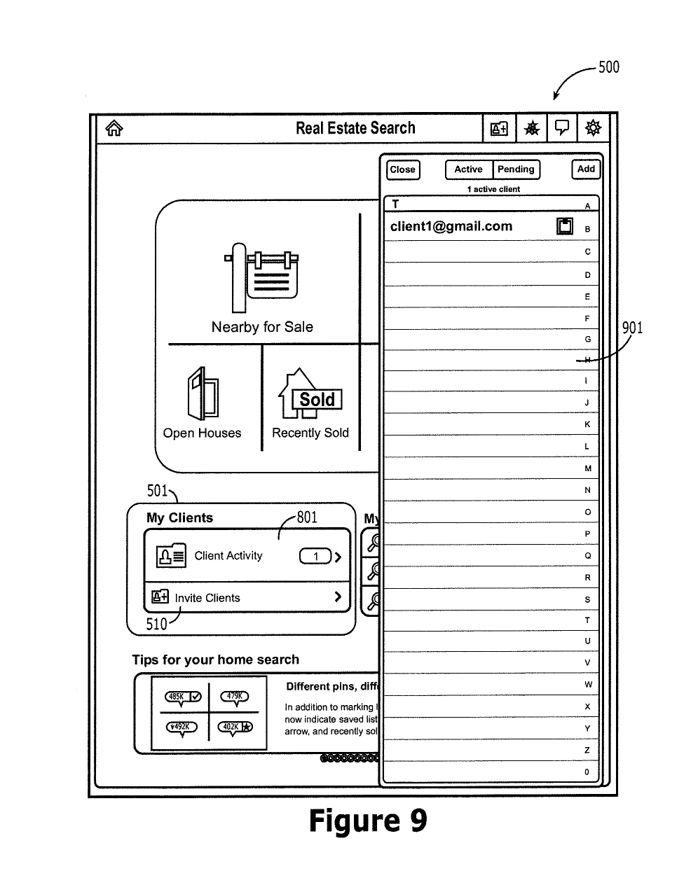

FIG. 9 again depicts the customized home screen viewable area 500 from the agent's perspective, but with the addition of a “client activity” viewable area 901, which may be caused to be presented in response to receiving selection of the “client activity” selectable element 801 in FIG. 8. From the client activity viewable area 901, the agent can see active (e.g., already established) and pending (e.g., a client has been invited to connect, but has not yet accepted) agent-client connections, and, by selecting a connected client, can view that client's activity, such as messages or properties received from the client or information regarding actions performed via the selected client's client device.

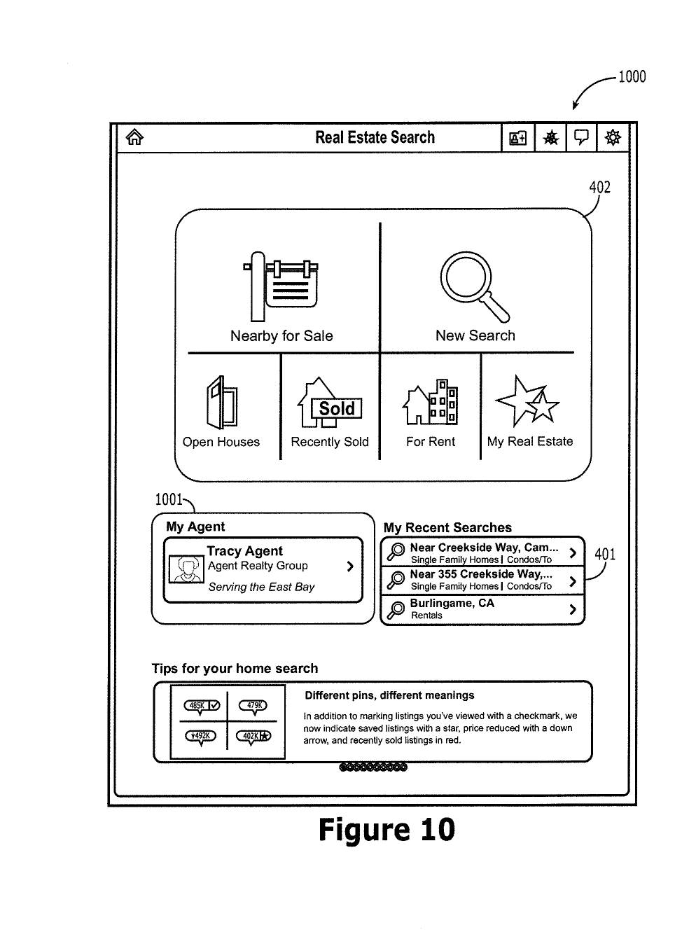

FIG. 10 depicts a customized home screen viewable area 1000 from the client's perspective. A “my agent” element 1001 may be provided to show the agent with whom the client has an agent-client connection. As with the “my clients” element 501 of FIG. 5 from the agent's perspective, the my agent element 1001 may not be populated if an agent-client connection has not been established with the client account associated with the client device. Here, however, an agent-client connection has been established and thus an indication of the client's connected agent is shown via the my agent element 1001. As can be seen, the indication may include the agent's name, a photo, the reality group the agent is associated with, and/or a tag line. As with the “my clients” element 501 of FIG. 5, selection of the agent that is presented may cause a “my agent” viewable area to be presented.

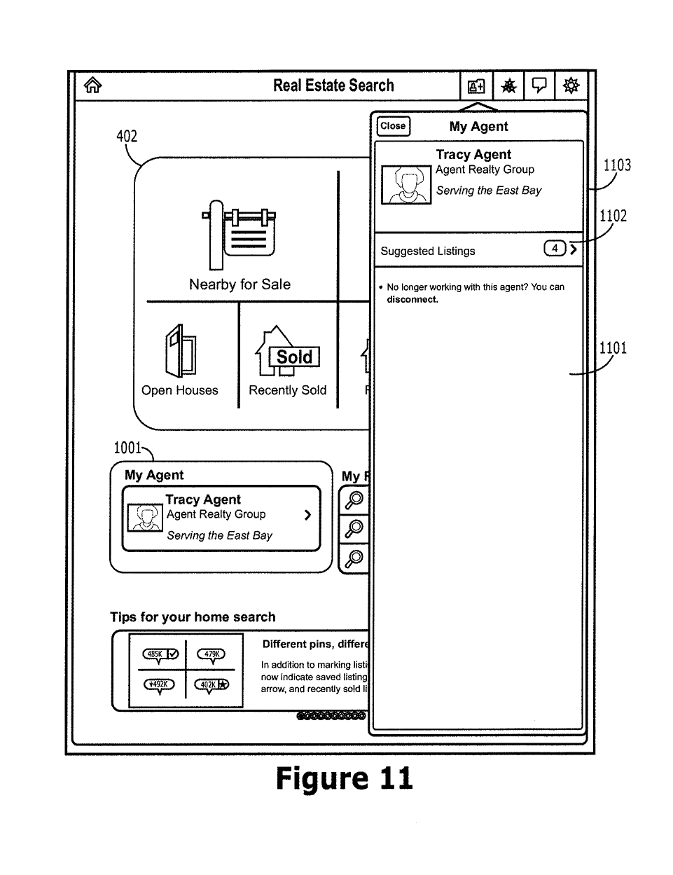

FIG. 11 depicts the abovementioned “my agent” viewable area 1101 from the client's perspective. As shown, the “my agent” viewable area 1101 includes an indication of the agent with which the client is connected 1103, along with a notification of received property listing suggestions 1102. In the depicted example, the client has received four suggested property listings.

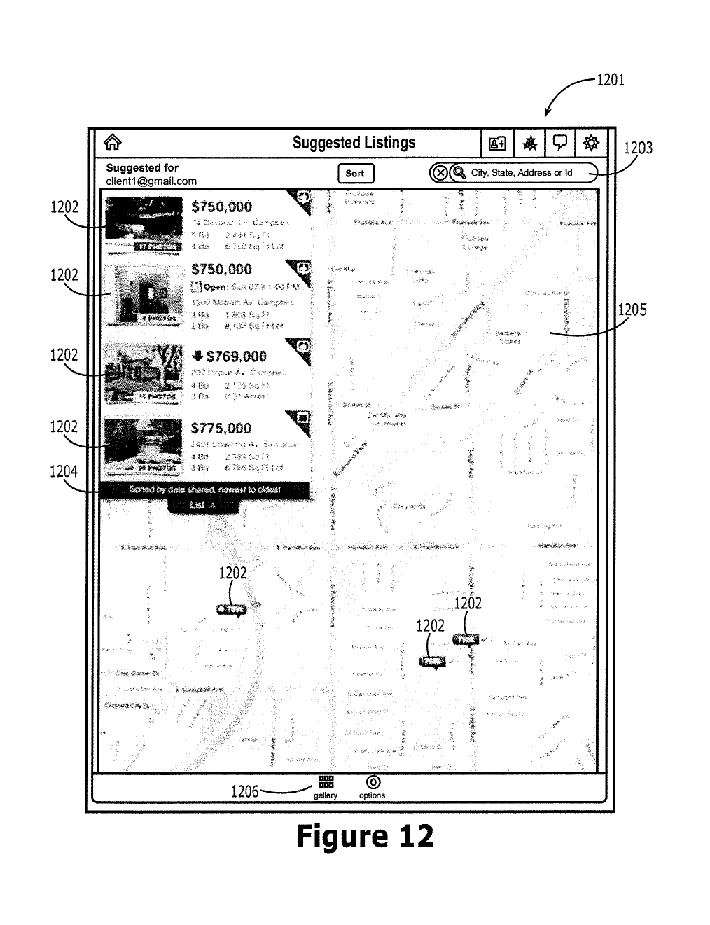

FIG. 12 depicts a “suggested listings” viewable area 1201 from the client's perspective. The “suggested listings” viewable area 1201 may be presented, for example, in response to the client selecting the notification of received property suggestions 1102 shown in FIG. 11. As shown, multiple suggested properties 1202 may be presented at once. The suggested properties 1202 may be presented in many formats, such as in a list, e.g., via “suggested properties list” viewable area 1204, via a map, such as via “map view” viewable area 1205, via a “gallery” viewable area (not depicted), or in multiple formats at once, as depicted. A search bar 1203 may also be provided to allow the client to search for additional properties, such as in the area of the suggested properties or according to other criteria provided by the user (e.g., price, amenities, etc.). A “view toggle” selectable element 1206 may also be provided. Receiving selection of the “view toggle” selectable element may toggle between different views of the suggested properties. For example, as depicted in viewable area 1201, a user may be able to toggle between the depicted “map view” and a “gallery view” (not depicted) in which the one or more suggested properties are presented in a photo gallery arrangement, e.g., with photos and/or other information regarding the properties arranged in a matrix.

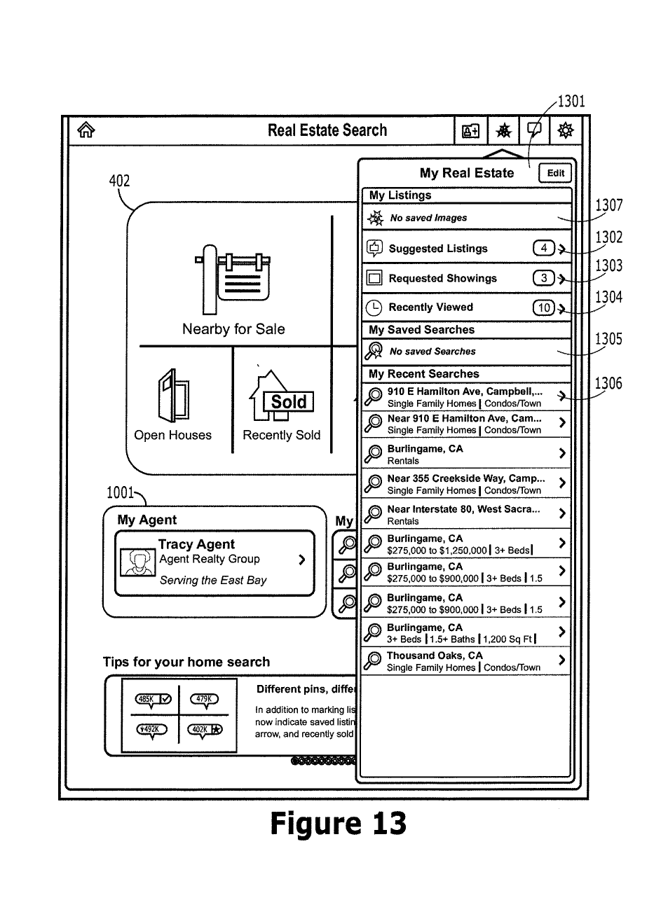

FIG. 13 depicts a “my real estate” viewable area 1301 from the client's perspective. The “my real estate” viewable area 1301 may be caused to be presented, for example, in response to selecting a “my real estate” selectable element, such as from the selectable home screen elements 402 of the customized client home screen viewable area 1000 depicted in FIG. 10. As shown, the “my real estate” viewable area 1301 may contain historical information, such as indicators for any previously suggested listings 1302 or requested showings 1303, as well as indicators for recently viewed property listings 1304, saved searches 1305, recent searches 1306, and saved listings 1307. Selection of any of these indicators may cause additional viewable areas to be presented. For example, selecting the suggested listings 1302 indicator, which may indicate the total number of suggested listings received so far, may cause the suggested listings viewable area 1201 of FIG. 12 to be presented; selecting the requested showings indicator 1303 may cause a “requested showings” viewable area (not depicted) similar to the suggested listings viewable area 1201 to be presented; and selecting the recently viewed indicator 1304 may cause a “recently viewed” viewable area (not depicted) similar to the suggested listings viewable area 1201 to be presented. Selecting one of the recent searches 1306 may similarly cause the results of the selected search (e.g., previously defined search criteria) to be presented, such as by re-running the search or presenting previously saved search results.

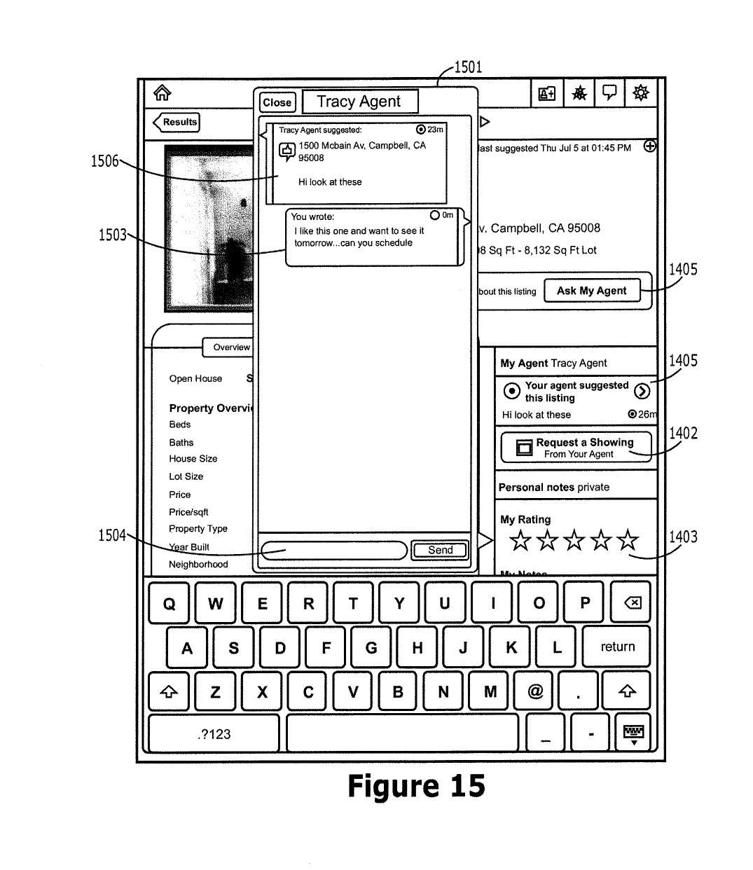

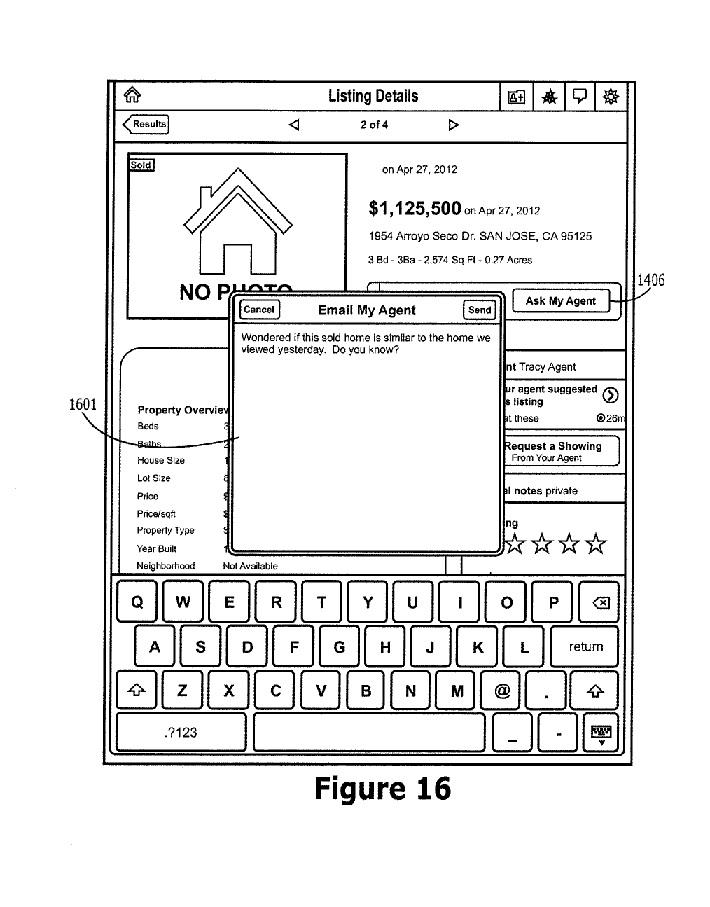

FIG. 14 shows a “property details” viewable area 1401 from the client's perspective. The “property details” viewable area 1401 may be presented, for example, in response to selecting a property listing, such as from suggested listings viewable area 1201 shown in FIG. 12, or from a list of properties returned in response to a search query. As shown, the “property details” viewable area 1401 may include a “showing request” selectable element 1402 which, upon selection, may cause the selected property listing shown in property details viewable area 1401 to be provided to the agent device, as discussed above. The “property details” viewable area 1401 may also include a rating element 1403, for allowing the user (e.g., the client) to select a rating for the property describing a level of interest the client has in the property, a notes area 1404 for receiving text input in the form of personal notes, and a “save this listing” selectable element 1407 for causing the depicted property listing to be saved for later viewing by the client, such as by selecting the saved listings indicator 1307 in the my real estate viewable area 1301 shown in FIG. 13. The property details viewable area 1401 may further include, in an instance in which the property listing was suggested by the client's agent, a “was suggested” indicator 1405, which indicates that the listing is a suggested property listing. As shown, the “was suggested” indicator 1405 may also indicate that a message has been received regarding the property listing. For example, at least a preview of a received message may be presented via the indicator, as depicted (“Hi look at these”). Selection of the “was suggested” indicator 1405 in an instance in which a message has been received may cause an additional viewable area to be presented, as will be discussed below in the context of FIG. 15. The property details viewable area 1401 may also include an “ask my agent” selectable element 1406. Selection of the “ask my agent” selectable element 1406 may cause an additional viewable area to be presented, as will be discussed below in the context of FIG. 16. The property details viewable area 1401 may also include details about the property listing 1408. The property details may include, for example, a number of bedrooms, a number of bathrooms, a size of the property, a lot size, a price, a price per square foot, a property type, a year that the property was built, a neighborhood in which the property is located, a status of the property, an identification number of the property, an address of the property, a broker associated with the property, listing information, a map of a location of the property, or a photo of the property, among other details describing the property.

FIG. 15 depicts a “messaging” viewable area 1501 from the client's perspective, which may be presented, for example, in response to selecting the “was suggested” indicator 1405 of FIG. 14 in an instance in which a message has been received from the agent relating to the suggested property. As shown, the “messaging” viewable area 1501 may include messages received from the agent 1502, any messages sent from the client 1503, and a text input area 1504 for receiving text input to compose additional messages relating to the suggested property.

FIG. 16 depicts an “email my agent” viewable area 1601 from the client's perspective. The “email my agent” viewable area 1601 may be presented, for example, in response to selecting the “ask my agent” selectable element 1406 mentioned above with respect to FIG. 14. From the “email my agent” viewable area 1601, the client may compose a message, e.g., an email, to be sent to the agent, such as a message relating to the property listing the client was viewing when they selected the “ask my agent” selectable element 1406 of FIG. 14.

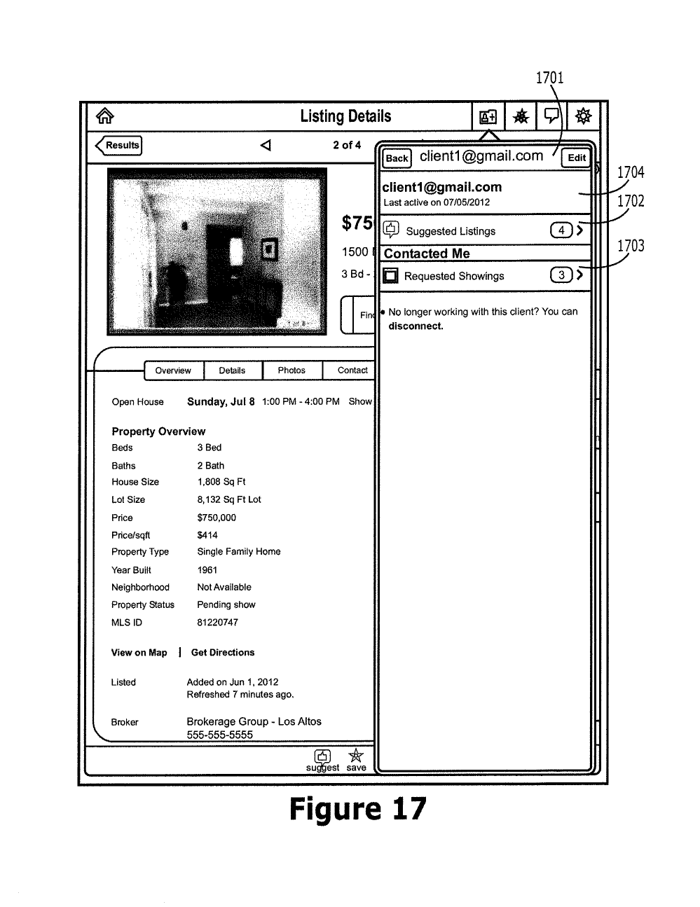

FIG. 17 returns to the agent's perspective and depicts a “client details” viewable area 1701 that may be presented to the agent via the agent's agent device. The “client details” viewable area 1701 may be presented, for example, in response to receiving selection of a client from the client activity viewable area 901 depicted in FIG. 9. As shown, the “client details” viewable area 1701 may include, for example, a suggested listings indicator 1702, a requested showings indicator 1703, and historical usage information 1704 for the client, such as, for example, when the client was last active (e.g., this client was “last active” on Jul. 5, 2012). Selection of the suggested listings 1702 or requested showings 1703 indicators may cause additional viewable areas to be presented. For example, selecting the suggested listings 1702 indicator may cause a viewable area similar to the suggested listings viewable area 1201 shown and described with reference to FIG. 12 to be presented; and selecting the requested showings indicator 1303 may cause a requested showings viewable area similar to the suggested listings viewable area 1201 shown and described with reference to FIG. 12 to be presented.

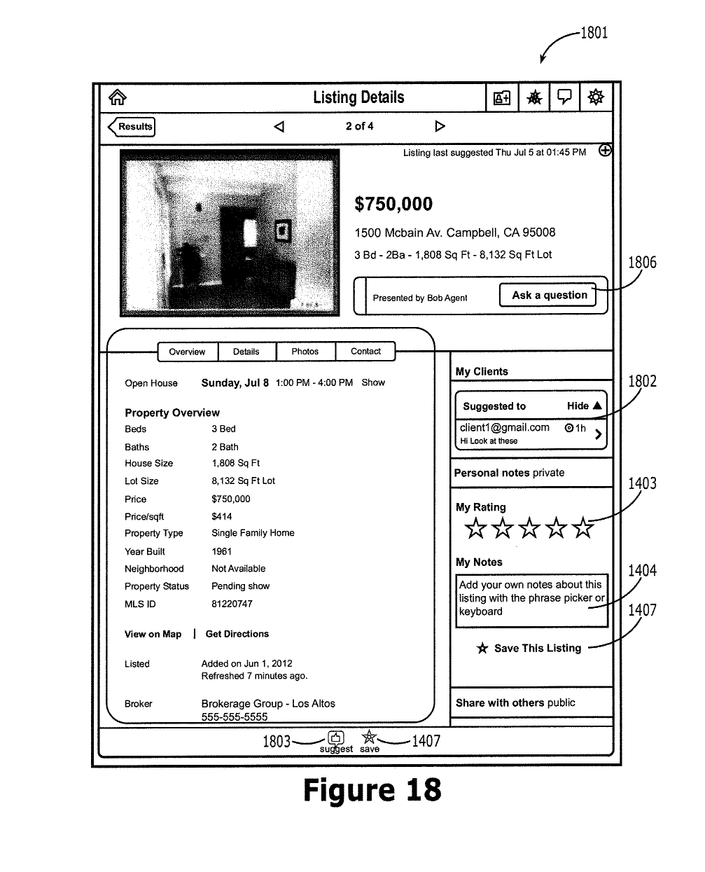

FIG. 18 shows a “property details” viewable area 1801 from the agent's perspective. As shown, the “property details” viewable area 1801 shown from the agent's perspective may be largely similar to the “property details viewable” area 1401 shown from the client's perspective in FIG. 14. However, the “property details” viewable area 1801 viewed from the agent's perspective includes an “ask a question” selectable element 1806, selection of which may open an “ask a question” viewable area (not depicted) similar to the “email my agent” viewable area 1601 of FIG. 16, the difference being that the message composed in the “ask a question” viewable area would be sent to a real estate agent or other contact person associated with the property listing (e.g., the seller's agent). The “property details” viewable area 1801 viewed from the agent's perspective also includes a selectable “property suggestion” element 1803, selection of which causes the property the property listing in “property details” viewable area 1801 to be shared with one or more connected clients, as discussed above. In addition, the “property details” viewable area 1801 viewed from the agent's perspective may include a “clients suggested to” indicator 1802 which indicates any clients to which the property listing was suggested. Selecting one of these clients' names may cause an additional viewable area to be presented, as discussed below.

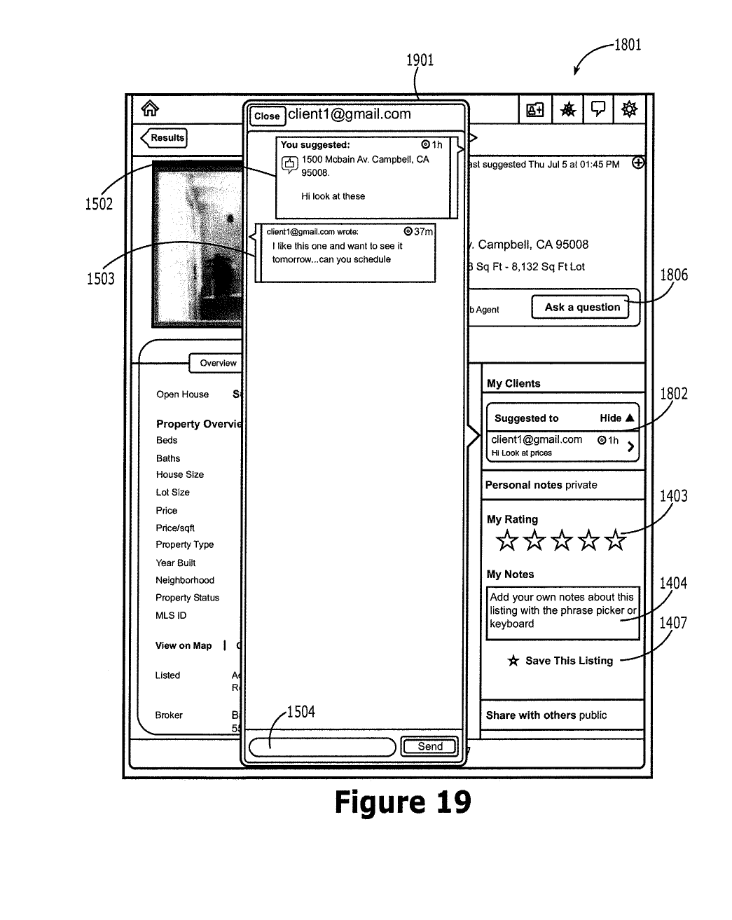

FIG. 19 depicts a “messaging” viewable area 1901 from the agent's perspective. The “messaging” viewable area 1901 from the agent's perspective may be presented in response to receiving selection of a client's name in the clients suggested to indicator 1801 shown in FIG. 18, as mentioned above. The “messaging” viewable area 1801 from the agent's perspective may be functionally identical to the “messaging” viewable area 1401 shown from the client's perspective in FIG. 14.

As described above, FIG. 3 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by a memory device 208 of an apparatus 200 employing an embodiment of the present invention and executed by a processor 202 of the apparatus 200. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or enhanced. Furthermore, in some embodiments, additional optional operations may be included. Modifications, additions, or enhancements to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed:

1. A method comprising:
causing an invitation to connect with an agent account to be transmitted from an agent device associated with the agent account to a client device associated with a client account;
receiving an indication of acceptance of the invitation from the client device; and
establishing, via a processor, an agent-client connection between the agent account and the client account in response to receipt of the indication of acceptance,
wherein the agent-client connection allows information regarding real estate to be shared between an agent and a client via a customized user interface of a respective one of the agent device or the client device.

2. The method of claim 1, further comprising, after establishing the agent-client connection between the agent account and the client account:
receiving a search query from the agent device or the client device;
causing one or more property listings to be provided to a respective one of the agent device or the client device in response to the search query;
receiving selection of one or more of the property listings via a respective one of the customized user interface of the agent device or the customized user interface of the client device; and
causing the selected one or more property listings to be provided to the other of the agent device or the client device in response to receipt of the selection.

3. The method of claim 2, further comprising causing information related to the selected one or more property listings to be presented via the customized user interface of the agent device or the customized user interface of the client device.

4. The method of claim 3, wherein, when presented via the customized user interface of the agent device, the information related to the selected one or more property listings comprises a selectable property suggestion element, the method further comprising:
receiving selection of the selectable property suggestion element via the customized user interface of the agent device;
causing a corresponding suggested property listing to be provided to the client device in response to receiving selection of the selectable property suggestion element; and
causing, in response to the client device receiving the corresponding suggested property listing, a property suggestion notification to be presented via the customized user interface of the client device.

5. The method of claim 3, wherein, when presented via the customized user interface of the client device, the information related to the property comprises a selectable showing request element, the method further comprising:
receiving selection of the selectable showing request element;
causing a corresponding requested property listing to be provided to the agent device in response to receiving selection of the selectable showing request element, and
causing, in response to the agent device receiving the corresponding requested property listing, a showing request notification to be presented via the customized user interface of the agent device.

6. The method of claim 1, wherein the invitation to connect with an agent account is a first invitation and the client device is a first client device that is associated with a first client account, the method further comprising:
causing a second invitation to connect with the agent account to be transmitted from the agent device associated with the agent account to a second client device associated with a second client account;
receiving a second indication of acceptance of the second invitation from the second client device; and
establishing a second agent-client connection between the agent account and the second client account;
wherein the second agent-client connection allows information regarding real estate to be shared between the agent and a second client via a customized user interface of a respective one of the agent device or the second client device.

7. The method of claim 1, wherein the invitation to connect with an agent account is a first invitation and the agent account is a first agent account associated with a first agent device and a first agent, the method further comprising:
causing a second invitation to connect with the first agent account to be transmitted from the first agent device to a second agent device associated with a second agent account;
receiving an indication of acceptance of the second invitation from the second agent device; and
establishing an agent-agent connection between the first agent account and the second agent account;
wherein the agent-agent connection allows information regarding real estate to be shared between the first agent and a second agent via a customized user interface of a respective one of the first agent device or the second agent device.

8. The method of claim 1, wherein the client device is a first client device that is associated with a first client account and a first client, the method further comprising:
causing an invitation to connect with the first client account to be transmitted from the client device associated with the client account to a second client device associated with a second client account;
receiving an indication of acceptance of the invitation to connect with the first client account from the second client device; and
establishing a client-client connection between the first client account and the second client account;
wherein the client-client connection allows information regarding real estate to be shared between the first client and a second client via a customized user interface of a respective one of the first device or the second client device.

9. A computer program product comprising a non-transitory computer readable medium having program code portions embodied therein, the program code portions being configured to, upon execution, direct an apparatus to at least:
cause an invitation to connect with an agent account to be transmitted from an agent device associated with the agent account to a client device associated with a client account;
receive an indication of acceptance of the invitation from the client device; and
establish, via a processor, an agent-client connection between the agent account and the client account in response to receipt of the indication of acceptance,
wherein the agent-client connection allows information regarding real estate to be shared between an agent and a client via a customized user interface of a respective one of the agent device or the client device.

10. The computer program product of claim 9, wherein the apparatus is further directed to, after establishing the agent-client connection between the agent account and the client account:
receive a search query from the agent device or the client device;
cause one or more property listings to be provided to a respective one of the agent device or the client device in response to the search query;
receive selection of one or more of the property listings via a respective one of the customized user interface of the agent device or the customized user interface of the client device; and
cause the selected one or more property listings to be provided to the other of the agent device or the client device in response to receipt of the selection.

11. The computer program product of claim 10, wherein the apparatus is further directed to cause information related to the selected one or more property listings to be presented via the customized user interface of the agent device or the customized user interface of the client device.

12. The computer program product of claim 11, wherein, when presented via the customized user interface of the agent device, the information related to the selected one or more property listings comprises a selectable property suggestion element, the apparatus being further directed to:
receive selection of the selectable property suggestion element via the customized user interface of the agent device;
cause a corresponding suggested property listing to be provided to the client device in response to receiving selection of the selectable property suggestion element; and
cause, in response to the client device receiving the corresponding suggested property listing, a property suggestion notification to be presented via the customized user interface of the client device.

13. The computer program product of claim 11, wherein, when presented via the customized user interface of the client device, the information related to the property comprises a selectable showing request element, the apparatus being further directed to:
receive selection of the selectable showing request element;
cause a corresponding requested property listing to be provided to the agent device in response to receiving selection of the selectable showing request element, and
cause, in response to the agent device receiving the corresponding requested property listing, a showing request notification to be presented via the customized user interface of the agent device.

14. The computer program product of claim 9, wherein the invitation to connect with an agent account is a first invitation and the client device is a first client device that is associated with a first client account, and the apparatus is further directed to:
cause a second invitation to connect with the agent account to be transmitted from the agent device associated with the agent account to a second client device associated with a second client account;
receive a second indication of acceptance of the second invitation from the second client device; and
establish a second agent-client connection between the agent account and the second client account;
wherein the second agent-client connection allows information regarding real estate to be shared between the agent and a second client via a customized user interface of a respective one of the agent device or the second client device.

15. The computer program product of claim 9, wherein the invitation to connect with an agent account is a first invitation and the agent account is a first agent account associated with a first agent device and a first agent, and the apparatus is further directed to:
cause a second invitation to connect with the first agent account to be transmitted from the first agent device to a second agent device associated with a second agent account;
receive an indication of acceptance of the second invitation from the second agent device; and
establish an agent-agent connection between the first agent account and the second agent account;
wherein the agent-agent connection allows information regarding real estate to be shared between the first agent and a second agent via a customized user interface of a respective one of the first agent device or the second agent device.

16. The computer program product of claim 9, wherein the client device is a first client device that is associated with a first client account and a first client, and the apparatus is further directed to:
cause an invitation to connect with the first client account to be transmitted from the client device associated with the client account to a second client device associated with a second client account;
receive an indication of acceptance of the invitation to connect with the first client account from the second client device; and
establish a client-client connection between the first client account and the second client account;
wherein the client-client connection allows information regarding real estate to be shared between the first client and a second client via a customized user interface of a respective one of the first device or the second client device.

17. An apparatus comprising at least one processor and at least one memory storing program code instructions, the at least one memory and program instructions being configured to, with the at least one processor, direct the apparatus to at least:
cause an invitation to connect with an agent account to be transmitted from an agent device associated with the agent account to a client device associated with a client account;
receive an indication of acceptance of the invitation from the client device; and
establish, via a processor, an agent-client connection between the agent account and the client account in response to receipt of the indication of acceptance,
wherein the agent-client connection allows information regarding real estate to be shared between an agent and a client via a customized user interface of a respective one of the agent device or the client device.

18. The apparatus of claim 19, wherein the apparatus is further directed to, after establishing the agent-client connection between the agent account and the client account:
receive a search query from the agent device or the client device;
cause one or more property listings to be provided to a respective one of the agent device or the client device in response to the search query;
receive selection of one or more of the property listings via a respective one of the customized user interface of the agent device or the customized user interface of the client device;
cause the selected one or more property listings to be provided to the other of the agent device or the client device in response to receipt of the selection; and
cause information related to the selected one or more property listings to be presented via the customized user interface of the agent device or the customized user interface of the client device.

19. The apparatus of claim 18, wherein, when presented via the customized user interface of the agent device, the information related to the selected one or more property listings comprises a selectable property suggestion element, the apparatus being further directed to:
receive selection of the selectable property suggestion element via the customized user interface of the agent device;
cause a corresponding suggested property listing to be provided to the client device in response to receiving selection of the selectable property suggestion element; and
cause, in response to the client device receiving the corresponding suggested property listing, a property suggestion notification to be presented via the customized user interface of the client device.

20. The apparatus of claim 18, wherein, when presented via the customized user interface of the client device, the information related to the property comprises a selectable showing request element, the apparatus being further directed to:
receive selection of the selectable showing request element;
cause a corresponding requested property listing to be provided to the agent device in response to receiving selection of the selectable showing request element, and cause, in response to the agent device receiving the corresponding requested property listing, a showing request notification to be presented via the customized user interface of the agent device.
